(19) United States
(12) Patent Application Publication
(10) Pub. No.: US 2006/0055152 A1
(43) Pub. Date: Mar. 16, 2006

(54) Frame structure for stroller

(76) Inventor: Mien Chen Huang, Tainan (TW)

Correspondence Address: PRO-TECHTOR INTERNATIONAL, 20775 Norada Court, Saratoga, CA, 95070-3018, US

(21) Appl. No.: 10/941,320

(22) Filed: Sep. 14, 2004

(51) Int. Cl. B62B 7/00

(52) U.S. Cl. 280/642

(57) ABSTRACT

Disclosed is a frame structure for stroller having a front connecting tube connected between the bottom ends of the front-leg tubes thereof to support the front wheel assemblies on the front-leg tubes such that the front wheel assemblies are received in the space horizontally between the two rear-leg tubes and vertically between the front connecting tube and a rear connecting tube that is connected between two rear-leg tubes when the frame structure for stroller is collapsed.

### BACKGROUND OF THE INVENTION

1. Field of the Invention

The present invention relates to children's gear and more particularly, to a frame structure for stroller that greatly reduces the width of the stroller when the collapsed the stroller.

2. Description of the Related Art

FIG. 1 shows the frame structure of a stroller according to the prior art. According to this design, the frame structure comprises two front-leg tubes 10, two rear-leg tubes 20, a substantially [symbol] -shaped handlebar 30, two seat tubes 40 pivoted to the front-leg tubes 10 and the rear-leg tubes 20 at two sides, a front connecting tube 50 connected between the bottom ends of the front-leg tubes 10, a rear connecting tube 60 connected between the bottom ends of the rear-leg tubes 20, two front wheel assemblies 70 provided at the bottom side of the front-leg tubes 10, two rear wheel assemblies 80 provided at the bottom side of the rear-leg tubes 20, two joints 90 bilaterally coupled between the front-leg tubes 10 and the two ends of the [symbol] -shaped handlebar 30 for enabling the frame structure to be set between the received position (see FIGS. 2 and 3) and the extended position (see FIG. 1). This design of frame structure for stroller is still not satisfactory in function. According to this design, the pitch between the front-leg tubes 10 is equal to the pitch between the rear-leg tubes 20. When the stroller is collapsed, as shown in FIGS. 2 and 3, the front wheel assemblies 70 are respectively stopped at the rear-leg tubes 20. Because the rear-leg tubes 20 interfere with the receiving of the front wheel assemblies 70, the width of the collapsed frame structure cannot be minimized, and much storage space is required for the collapsed frame structure during delivery.

### SUMMARY OF THE INVENTION

The present invention has been accomplished under the circumstances in view. It is one object of the present invention to provide a frame structure for stroller, which greatly reduces the width of the stroller when the frame structure is collapsed.

To achieve this and other objects of the present invention, the frame structure for stroller comprises two front-leg tubes, two rear-leg tubes, a substantially [symbol] -shaped handlebar, two seat tubes pivoted to the front-leg tubes and the rear-leg tubes at two sides, a rear connecting tube joining the bottom ends of the rear-leg tubes, two front wheel assemblies coupled to the front-leg tubes at a bottom side, two rear wheel assemblies coupled to the bottom ends of the rear-leg tubes, two joints bilaterally coupled between the front-leg tubes and two distal ends of the [symbol] -shaped handlebar for enabling the frame structure for stroller to be turned between a received position and an extended position, wherein a front connecting tube is connected between the bottom ends of the front-leg tubes to support the front wheel assemblies on the front-leg tubes such that the front wheel assemblies are received in the space horizontally between the two rear-leg tubes and vertically between the front connecting tube and the rear connecting tube when the frame structure for stroller is set in the received position.

### BRIEF DESCRIPTION OF THE DRAWINGS

FIG. 1 is a perspective view of a frame structure for stroller according to the prior art.

FIG. 2 is a side view showing the frame structure for stroller collapsed according to the prior art.

FIG. 3 is a front view of FIG. 2.

FIG. 4 is a perspective view of a frame structure for stroller according to the present invention.

FIG. 5 illustrates the collapsed status of the frame structure for stroller shown in FIG. 4.

FIG. 6 is a perspective view of an alternate form of the frame structure for stroller according to the present invention.

FIG. 7 illustrates the collapsed status of the frame structure for stroller shown in FIG. 6.

FIG. 8 is a schematic drawing showing another alternate form of the present invention.

FIG. 9 is a schematic drawing showing still another alternate form of the present invention.

FIG. 10 is similar to FIG. 4 but showing the front wheel assemblies respectively inwardly turned through 90 angles relative to the front-leg tubes.

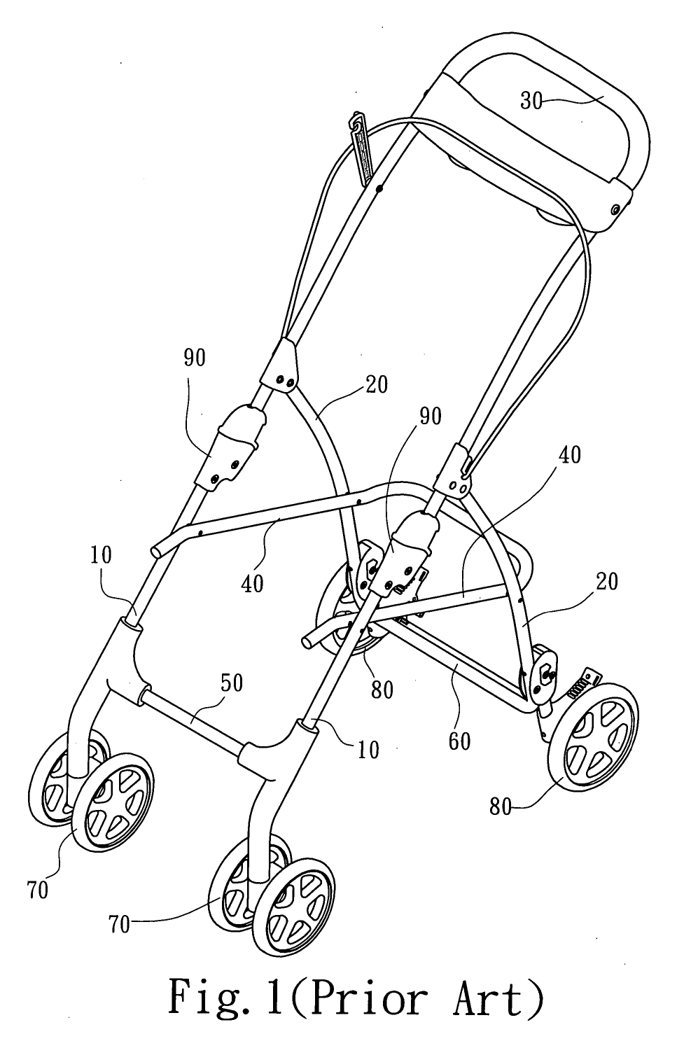

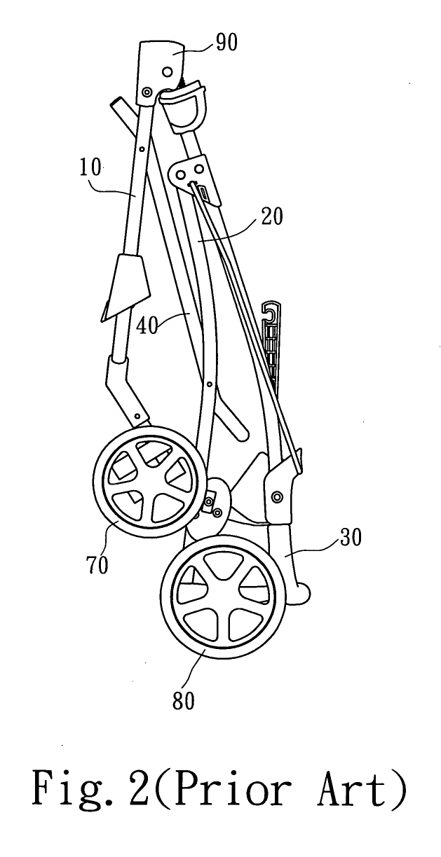

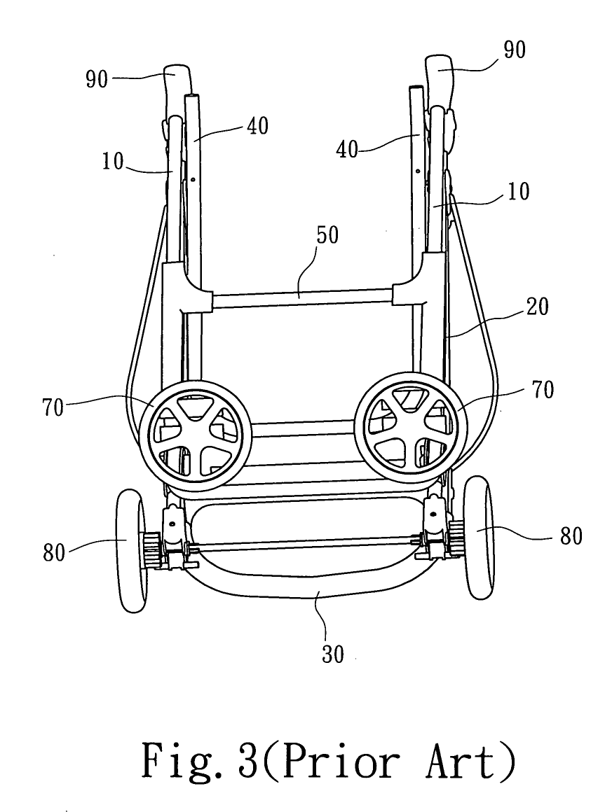

### DETAILED DESCRIPTION OF THE PREFERRED EMBODIMENT

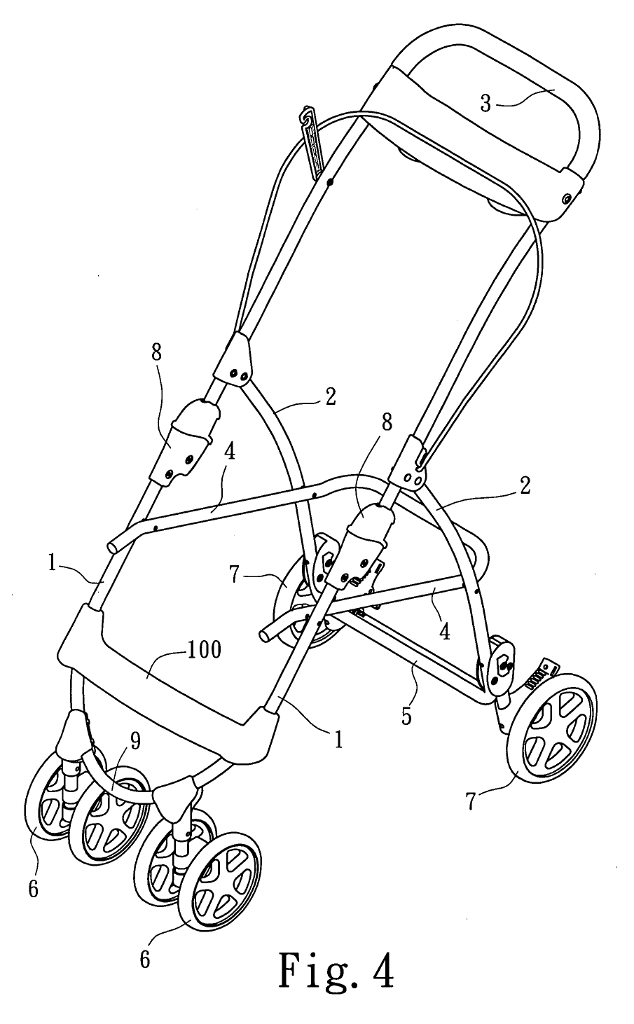

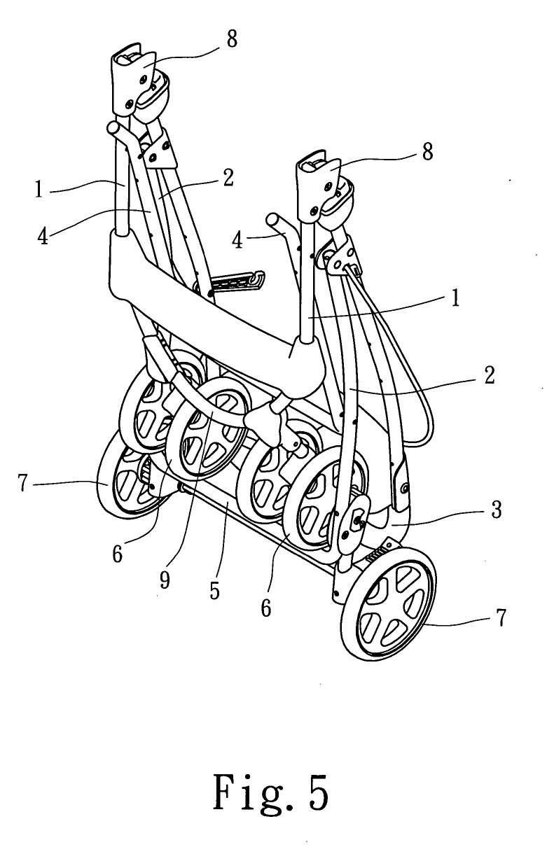

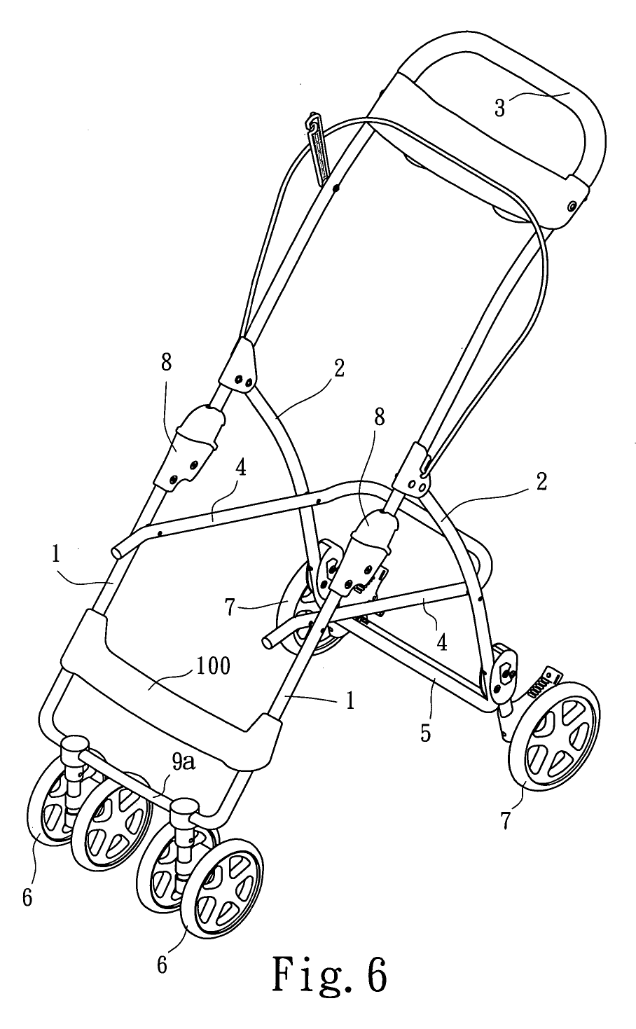

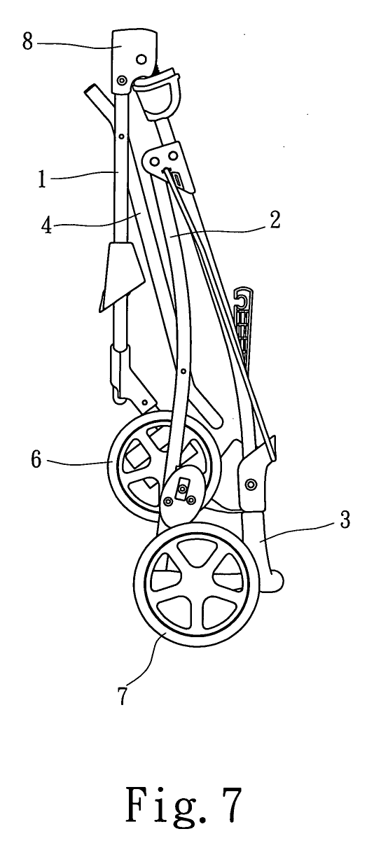

Referring to FIGS. 4 and 5, a frame structure for stroller in accordance with the present invention is shown comprising two front-leg tubes 1, two rear-leg tubes 2, a substantially [symbol] -shaped handlebar 3, two seat tubes 4 pivoted to the front-leg tubes 1 and the rear-leg tubes 2 at two sides, a rear connecting tube 5 joining the bottom ends of the rear-leg tubes 2, two front wheel assemblies 6 provided at the bottom side of the front-leg tubes 1, two rear wheel assemblies 7 provided at the bottom side of the rear-leg tubes 2, two joints 8 bilaterally coupled between the front-leg tubes 1 and the two ends of the [symbol] -shaped handlebar 3 for enabling the frame structure to be turned between the received position as shown in FIG. 5 and the extended position as shown in FIG. 4.

Referring to FIGS. 4 and 5 again, a front connecting tube 9 is connected between the bottom ends of the front-leg tubes 1, and a footplate 100 is connected between the front-leg tubes 1 and spaced above the front connecting tube 9. According to this embodiment, the front connecting tube 9 is an arched tube smoothly curved downwards and formed integral with the bottom ends of the front-leg tubes 1. The two front wheel assemblies 6 are fastened to the front connecting tube 9. When the user collapsed the frame structure as shown in FIG. 5, the two front wheel assemblies 6 are received in the space horizontally between the two rear-leg tubes 2 and vertically between the front connecting tube 9 and the rear connecting tube 5.

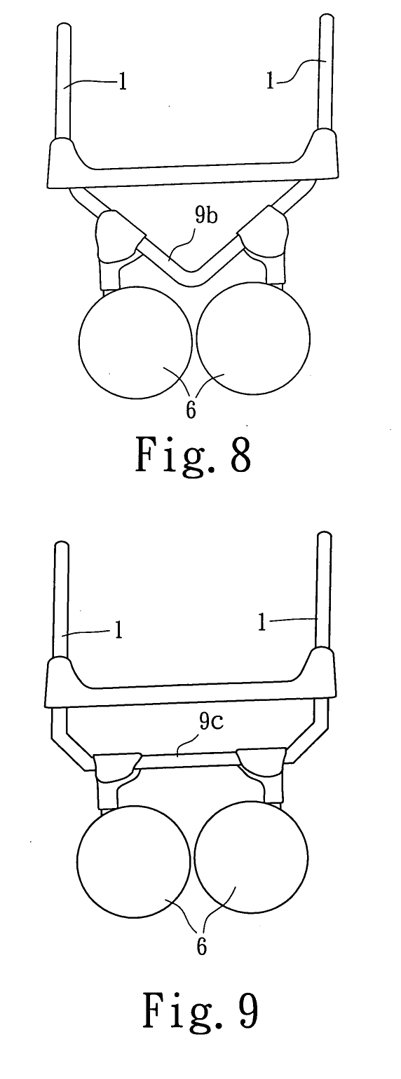

FIGS, 6 and 7 show an alternate form of the frame structure for stroller according to the present invention. This embodiment is substantially similar to the embodiment shown in FIGS. 4 and 5 with the exception that the front connecting tube 9a of this embodiment is a transverse tube horizontally connected between the bottom ends of the front-leg tubes 1. FIG. 8 shows another alternate form of the present invention. According to this embodiment, the front connecting tube, referenced by 9b, is an angle bar. FIG. 9 shows still another alternate form of the present invention. According to this embodiment, the front connecting tube, referenced by 9c, is a polygonal bar.

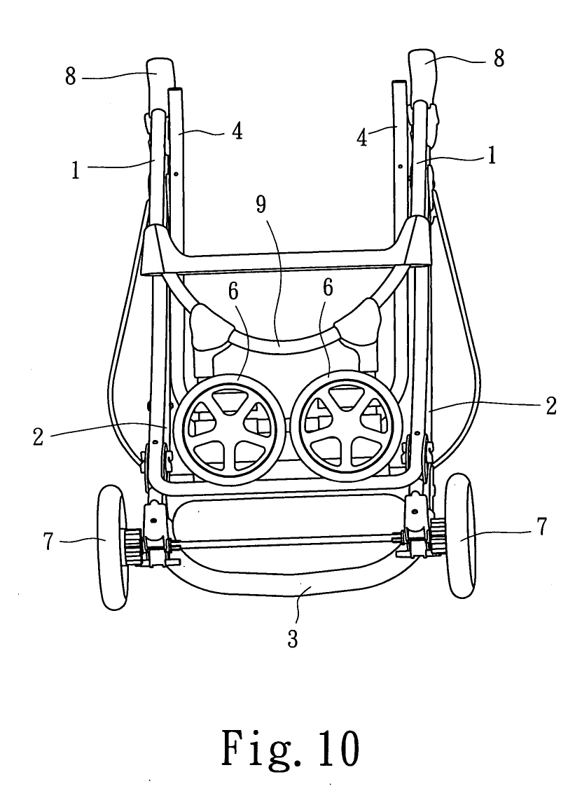

FIG. 10 is a front view corresponding to FIG. 4, showing the front wheel assemblies 6 respectively inwardly turned through 90 angles relative to the front-leg tubes.

As indicated above, the frame structure for stroller according to the present invention is so arranged that the front wheel assemblies 6 will be received in the space horizontally between the two rear-leg tubes 2 and vertically between the front connecting tube 9, 9a, 9b, 9c and the rear connecting tube 5 when the user collapsed the frame structure for stroller. This arrangement greatly reduces the width of the collapsed status of the frame structure for stroller.

A prototype of frame structure for stroller has been constructed with the features of FIGS. 4˜9. The frame structure for stroller functions smoothly to provide all of the features discussed earlier.

Although particular embodiments of the invention have been described in detail for purposes of illustration, various modifications and enhancements may be made without departing from the spirit and scope of the invention.

What the invention claimed is:

1. A frame structure for stroller comprising two front-leg tubes, said front-leg tubes each having a bottom end, two rear-leg tubes, said rear-leg tubes each having a bottom end, a substantially [symbol] -shaped handlebar, two seat tubes pivoted to said front-leg tubes and said rear-leg tubes at two sides, a rear connecting tube joining the bottom ends of said rear-leg tubes, two front wheel assemblies coupled to said front-leg tubes at a bottom side, two rear wheel assemblies coupled to the bottom ends of said rear-leg tubes, two joints bilaterally coupled between said front-leg tubes and two distal ends of said [symbol] -shaped handlebar for enabling the frame structure for stroller to be turned between a received position and an extended position, wherein a front connecting tube is connected between the bottom ends of said front-leg tubes to support said front wheel assemblies on said front-leg tubes such that said front wheel assemblies are received in the space horizontally between said two rear-leg tubes and vertically between said front connecting tube and said rear connecting tube when the frame structure for stroller is set in said received position.

2. The frame structure for stroller as claimed in claim 1, wherein said front connecting tube is an arched tube smoothly curved downwards.

3. The frame structure for stroller as claimed in claim 1, wherein said front connecting tube is a transverse tube horizontally connected between the bottom ends of said front-leg tubes.

4. The frame structure for stroller as claimed in claim 2, wherein said front connecting tube has two ends respectively formed integral with the bottom ends of said front-leg tubes.

5. The frame structure for stroller as claimed in claim 1, wherein said front connecting tube is an angle tube.

6. The frame structure for stroller as claimed in claim 1, wherein said front connecting tube is a polygonal tube.

7. The frame structure for stroller as claimed in claim 1, further comprising a footplate connected between said front-leg tubes and spaced above said front connecting tube.

8. The frame structure for stroller as claimed in claim 2, further comprising a footplate connected between said front-leg tubes and spaced above said front connecting tube.
